(19) United States
(12) Patent Application Publication
(10) Pub. No.: US 2021/0236364 A1
(43) Pub. Date: Aug. 5, 2021

(54) PRONE-TO-SUPINE TRANSFER MATTRESS

(71) Applicant: Intensive Therapeutics, Inc., Sarasota, FL (US)

(72) Inventor: Matthew DuDonis, Sarasota, FL (US)

(73) Assignee: Intensive Therapeutics, Inc., Sarasota, FL (US)

(21) Appl. No.: 16/650,280

(22) PCT Filed: Apr. 3, 2019
(86) PCT No.: PCT/US19/25528

§ 371 Date: Mar. 24, 2020

(51) Int. Cl. A61G 7/10; A61G 7/00

(52) U.S. Cl. CPC A61G 7/1028; A61G 7/001

(57) ABSTRACT

A mattress includes a pair of first panels connected to each other and defining a first air pocket therebetween; and a pair of second panels connected to each other and defining a second air pocket therebetween. The pair of first panels and the pair of second panels are operatively connected to each other defining a space between the pair of first panels and the pair of second panels. The pair of first panels and the second pair of panels each have collapsible pleats to control a volume of the space.

### BACKGROUND

### Technical Field

The embodiments herein generally relate to mattress assemblies, and more particularly to mattress assemblies for medical uses to allow transfer of patients into different positions.

### Description of the Related Art

The use of air powered lateral transfer mattresses is a recognized and widely accepted means of handling the transfers of immobile patients across the healthcare workplace. Conventional devices are generally designed to transfer patients from one flat, horizontal surface to another flat horizontal surface. If a patient has to be rotated from a prone-to-supine position, or vice versa, typically healthcare workers have to directly rotate the patient or use large and complex electro-mechanical machinery to rotate the patient. Such techniques may further be complicated due to spatial restrictions in the area where the patient is located as well as the size of the patient and potentially limited abilities of the healthcare workers to properly rotate the patient without causing injury to either the worker or the patient, or both. Furthermore, the conventional devices also tend to suffer from not being suitably portable or easily stored after use. The supine to prone to supine maneuver is used often in the critical care or trauma care environments to position patients with Acute Respiratory Distress Syndrome (ARDS) into the prone position for mechanical ventilation. Accordingly, a new mechanism is needed to help nurses, therapists, and other healthcare workers to perform this maneuver in a safer way with less risk of injury for all individuals involved. Furthermore, the ability to be able to laterally transfer a patient remains a necessity for many situations to ensure proper placement and positioning of a patient on a hospital bed, etc.

### SUMMARY

In view of the foregoing, an embodiment herein provides a mattress comprising a pair of first panels connected to each other and defining a first air pocket therebetween; and a pair of second panels connected to each other and defining a second air pocket therebetween, wherein the pair of first panels and the pair of second panels are operatively connected to each other defining a space between the pair of first panels and the pair of second panels, and wherein the pair of first panels and the second pair of panels each comprise collapsible pleats to control a volume of the space.

The mattress may comprise a first set of baffles separating the pair first panels from each other; and a second set of baffles separating the pair of second panels from each other. The mattress may comprise a mechanism to collapse and retain the pleats in a closed position. The closed position of the pleats may cause the volume of any of the first air pocket and the second air pocket to reduce. The mattress may comprise at least one air flow perforation in a first panel of the pair of first panels, wherein the first panel is positioned away from the space, and wherein the at least one air flow perforation permits air to flow from the first air pocket. The mattress may comprise a handle connected to an edge of a second panel of the pair of first panels. The mattress may comprise a handle connected to a surface of the first panel, wherein the surface is positioned away from the space. The mattress may comprise at least one air flow perforation in a first panel of the pair of second panels, wherein the first panel is positioned away from the space, and wherein the at least one air flow perforation permits air to flow from the second air pocket. The mattress may comprise a handle connected to an edge of a second panel of the pair of second panels. The mattress may comprise a handle connected to a surface of the first panel, wherein the surface is positioned away from the space.

Another embodiment provides a mattress comprising a first inflatable cushion comprising a first crease; a second inflatable cushion comprising a second crease, wherein the second inflatable cushion is operatively connected to the first inflatable cushion; a space between the first inflatable cushion and the second inflatable cushion; and a mechanism to fold of any of the first crease and the second crease. The mattress may comprise a first mechanism on the first inflatable cushion to receive a first flow of air to inflate the first inflatable cushion; and a second mechanism on the second inflatable cushion to receive a second flow of air to inflate the second inflatable cushion. Folding of any of the first crease and the second crease may control an internal volume of any of the first inflatable cushion and the second inflatable cushion. The space may be configured to hold a person, and the rotation of the mattress may cause rotation of the person. The mattress may allow lateral transfer of the person.

Another embodiment provides a mattress comprising a first inflatable cushion comprising a first set of pleats that are configured to open and close; and a first set of perforations to exhaust a first flow of air transmitted through the first inflatable cushion. The mattress comprises a second inflatable cushion detachably connected to the first inflatable cushion, wherein the second inflatable cushion comprises a second set of pleats that are foldable; and a second set of perforations to exhaust a second flow of air transmitted through the second inflatable cushion, wherein closing of any of the first set of pleats and the second set of pleats is to define a space between the first inflatable cushion and the second inflatable cushion and reduces an interior volume in any of the first inflatable cushion and the second inflatable cushion upon inflation of any of the first inflatable cushion and the second inflatable cushion.

The first flow of air exhausted through the first set of perforations may reduce friction between the first inflatable cushion and an underlying surface to permit rotational movement of the first inflatable cushion at a reduced required transfer force. The second flow of air exhausted through the second set of perforations may reduce friction between the second inflatable cushion and an underlying surface to permit rotational movement of the second inflatable cushion at a reduced required transfer force. Each of the first inflatable cushion and the second inflatable cushion may comprise a perforation portion and a non-perforation portion. The non-perforation portion may comprise at least one handle that lies substantially flat against the non-perforation portion.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic diagram illustrating a cross-sectional view of a mattress, according to a first embodiment herein.

FIG. 2 is a schematic diagram illustrating a cross-sectional view of the mattress of FIG. 1 with first and second baffles, according to an embodiment herein.

FIG. 3 is a schematic diagram illustrating a cross-sectional view of the mattress of FIG. 1 with a mechanism to engage the pleats of the mattress, according to an embodiment herein.

FIG. 4 is a schematic diagram illustrating a cross-sectional view of the mattress of FIG. 1 with handles, according to an embodiment herein.

FIG. 5 is a schematic diagram illustrating an exploded view of the top panel, bottom panel, and baffles, according to an embodiment herein.

FIG. 6A is a schematic diagram illustrating a cross-sectional view of a mattress, according to an embodiment herein.

FIG. 6B is a schematic diagram illustrating a plan view of the mattress of FIG. 6A, according to an embodiment herein.

FIG. 6C is a schematic diagram illustrating a mattress with pleats in an open configuration, according to an embodiment herein.

FIG. 6D is a schematic diagram illustrating a mattress with pleats in a closed configuration, according to an embodiment herein.

FIG. 7A is a schematic diagram illustrating a cross-sectional view of a mattress with an open configuration of pleats, according to an embodiment herein.

FIG. 7B is a schematic diagram illustrating a cross-sectional view of a mattress with a closed configuration of pleats, according to an embodiment herein.

FIG. 8A is a schematic diagram illustrating a cross-sectional view of a mattress rotated 180°, according to an embodiment herein.

FIG. 8B is a schematic diagram illustrating a cross-sectional view of a mattress rotated another 180°, according to an embodiment herein.

FIG. 9 is a schematic diagram illustrating a cross-sectional view of a mattress with handles on a non-perforation portion of the mattress, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

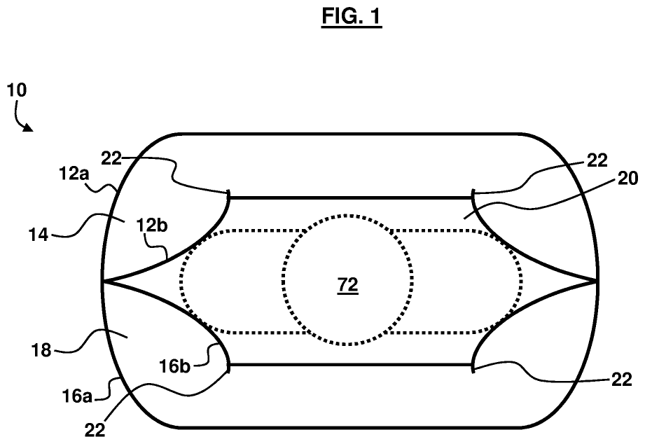

The embodiments herein provide a mattress that can be used for lateral transfer of a patient as well as rotating a patient from supine-to-prone position and from prone-to-supine position. Moreover, the embodiments herein can be used for turning/rotating patients 180°, from the flat lying supine position to the flat lying prone position or from the prone position to the supine position. In order to be used for the supine-to-prone maneuver, the embodiments herein provide a modified lateral transfer mattress that is configured in a crescent or half-hexagon shape. Later, once the rotating maneuver is performed, the mattress may be converted to be used for positioning across a horizontal surface once again for lateral transfer of a patient. Accordingly, the embodiments herein provide a lateral transfer mattress that is convertible and can change duty, from a lateral transfer modality to a supine-to-prone modality. Referring now to the drawings, and more particularly to FIGS. 1 through 9, where similar reference characters denote corresponding features consistently throughout, there are shown exemplary embodiments. In the drawings, the size and relative sizes of components, layers, and regions may be exaggerated for clarity.

FIG. 1 illustrates a mattress 10 comprising a pair of first panels 12a, 12b connected to each other and defining a first air pocket 14 therebetween. The pair of first panels 12a, 12b may be configured as substantially horizontal lying sheets of fabric each approximating the length and width of a standard or bariatric hospital bed/mattress, stretcher, or surgery table. The pair of first panels 12a, 12b are substantially flat and uninterrupted from side-to-side and head-to-foot in an uninflated configuration. The connected pair of first panels 12a, 12b may be inflatable to create the first air pocket 14 between the pair of first panels 12a, 12b. The first air pocket 14 may be pressurized at any suitable pressure level and the pair of first panels 12a, 12b may comprise sufficient material strength properties to provide an inflatable cushion, due to the air provided in the first air pocket 14, for accommodating a patient that is disposed thereon.

The mattress 10 comprises a pair of second panels 16a, 16b connected to each other and defining a second air pocket 18 therebetween. The pair of second panels 16a, 16b may be configured as substantially horizontal lying sheets of fabric each approximating the length and width of a typical hospital bed/mattress. The pair of second panels 16a, 16b are substantially flat and uninterrupted from side-to-side and head-to-foot in an uninflated configuration. The connected pair of second panels 16a, 16b may be inflatable to create the second air pocket 18 between the pair of second panels 16a, 16b. The second air pocket 18 may be pressurized at any suitable pressure level and the pair of second panels 16a, 16b may comprise sufficient material strength properties to provide an inflatable cushion, due to the air provided in the second air pocket 18, for accommodating a patient that is disposed thereon. In an example, the first air pocket 14 and the second air pocket 18 may contain a substantially equal amount of air upon respective inflation. In another example, the first air pocket 14 and the second air pocket 18 may contain a different amount of air upon respective inflation.

The pair of first panels 12a, 12b and the pair of second panels 16a, 16b are operatively connected to each other defining a space 20 between the pair of first panels 12a, 12b and the pair of second panels 16a, 16b. The space 20 may be configured as a chamber for securing a patient 72 positioned therein. Accordingly, a patient 72 may be positioned in the space 20 prior to connection of the pair of first panels 12a, 12b and the pair of second panels 16a, 16b to one another. The pair of first panels 12a, 12b and the second pair of panels 16a, 16b each comprise collapsible pleats 22 to control a volume of the space 20. The pleats 22 may be collapsed, folded, fastened, or otherwise closed thereby reducing the size of the pair of first panels 12a, 12b and the second pair of panels 16a, 16b. In some examples, the pair of first panels 12a, 12b and the second pair of panels 16a, 16b may comprise nylon taffeta material or high-density polyethylene fiber material or similar material.

When the pair of first panels 12a, 12b and the pair of second panels 16a, 16b are connected together, the patient 72 positioned in the space 20 may be rotated along a longitudinal axis of the patient 72 such that the mattress 10 is rotated from a prone-to-supine position and vice versa. When the pair of first panels 12a, 12b and the pair of second panels 16a, 16b are disconnected from each other, the patient 72 may be positioned on any of the panels 12b, 16b for lateral transfer of the patient 72 (e.g., from one bed to another, etc.). Moreover, in an example, the pair of first panels 12a, 12b and the pair of second panels 16a, 16b may be partially connected together (e.g., connected on one side) to create a larger/oversized mattress 10 that may be used for lateral movement or transfer of the patient 72, which may be suitable for larger-sized patients or multiple patients, etc.

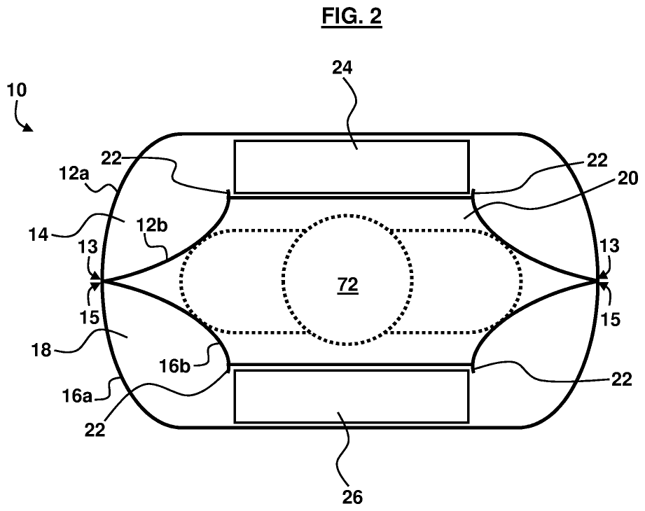

FIG. 2, with reference to FIG. 1, illustrates that the mattress 10 comprises a first set of baffles 24 separating the pair first panels 12a, 12b from each other. A second set of baffles 26 may be provided for separating the pair of second panels 16a, 16b from each other. The first set of baffles 24 and the second set of baffles 26 may be configured as a plurality of vertical columns or struts which hold the pair first panels 12a, 12b together and the pair of second panels 16a, 16b together, and prevent the pair of first panels 12a, 12b and the pair of second panels 16a, 16b from taking a cylindrical shape with the force of the pressurized air in the first air pocket 14 and the second air pocket 18. Seams 13 sewn or ultrasonically welded around the perimeter of the pair first panels 12a, 12b also connect the first set of baffles 24 to the pair first panels 12a, 12b. Moreover, seems 15 sewn or ultrasonically welded around the perimeter of the pair of second panels 16a, 16b also connect the second set of baffles 26 to the pair of second panels 16a, 16b. The first set of baffles 24 and the second set of baffles 26 may comprise nylon taffeta material or high-density polyethylene fiber material or similar material, according to some examples. In some examples, the first set of baffles 24 may be operatively connected to one another through a series of interleaving guides or other material or components (not shown). In other examples, the first set of baffles 24 are separate, unconnected, and distinct structures from one another. Similarly, in some examples, the second set of baffles 26 may be operatively connected to one another through a series of interleaving guides or other material or components (not shown). In other examples, the second set of baffles 26 are separate, unconnected, and distinct structures from one another.

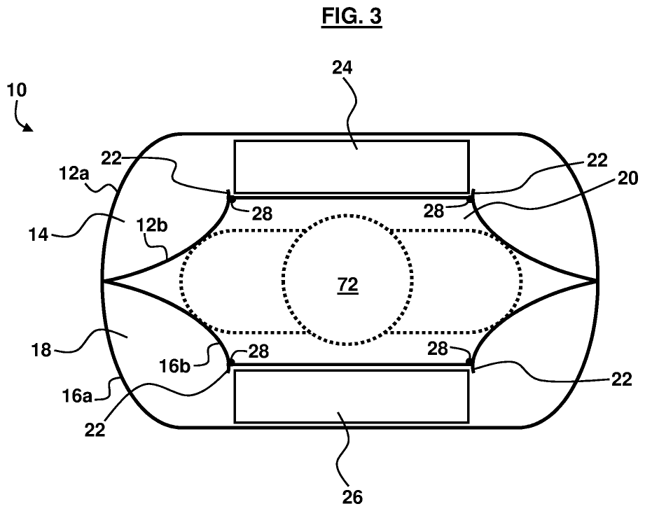

FIG. 3, with reference to FIGS. 1 and 2, illustrates that the mattress 10 comprises a mechanism 28 to collapse and retain the pleats 22 in a closed position. Example configurations of the mechanism 28 may comprise a zipper, hook and loop enclosure, plastic snaps, metal snaps, buttons, buckles, tracks, magnets, hook and eye, press studs, grommets, drawstrings, metal or plastic bars, or other mechanism that function to securely collapse and retain the pleats 22. The closed position of the pleats 22 causes any of the first air pocket 14 and the second air pocket 18 to reduce in size. Additionally, the closed position of the pleats 22 may further define the space 20 where a person (e.g., the patient 72) can be placed.

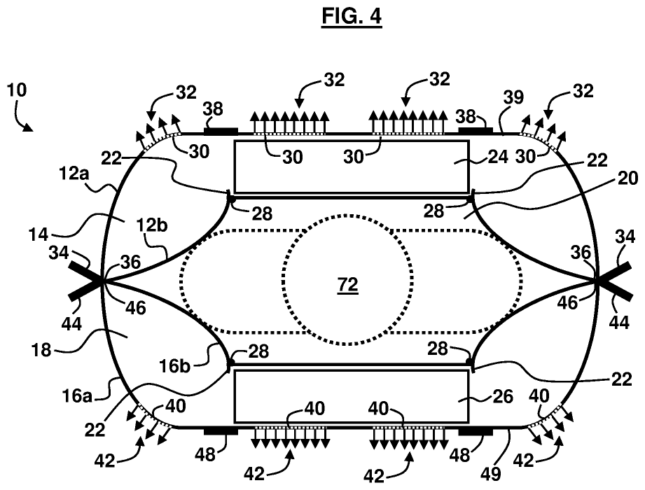

FIG. 4, with reference to FIGS. 1 through 3, illustrates that the mattress 10 comprises at least one air flow perforation 30 in a first panel 12a of the pair of first panels 12a, 12b. The first panel 12a is positioned facing away from the space 20. The at least one air flow perforation 30 permits air 32 to flow from the first air pocket 14. The at least one air flow perforation 30 may be configured as an array of small pinholes of any suitable size, which allow the pressurized air 32 to flow through the first panel 12a. The air 32 acts as a lubricant between the lateral transfer mattress 10 (when the panel 12a is facing downward) and an underlying surface (not shown in FIG. 4), such as a bed, etc., upon which the mattress 10 is being operated, which permits a patient 72 to be transferred with a minimum amount of effort, thereby reducing the risk of musculoskeletal injuries for both the patient 72 and the medical personnel moving and/or rotating the mattress 10 with the patient 72 positioned therein/thereon. As further shown in FIG. 4, the mattress 10 comprises a handle 34 connected to an edge 36 of a second panel 12b of the pair of first panels 12a, 12b. The handle 34 may be made of plastic, rubber, metal, or any other suitable material and may be secured to the second panel 12b. In an example, the handle 34 can be used to maneuver the mattress 10 or the pair of first panels 12a, 12b, or can be used as a mechanism to secure the mattress 10 to an underlying surface (e.g., bed, etc.). As further shown in FIG. 4, the mattress 10 comprises a handle 38 connected to a surface 39 of the first panel 12a. The surface 39 is positioned facing away from the space 20. The handle 38 may be positioned to be substantially flat against the surface 39 of the first panel 12a, and the handle 38 may comprise the same type of material as the first panel 12a, in an example.

As further shown in FIG. 4, the mattress 10 comprises at least one air flow perforation 40 in a first panel 16a of the pair of second panels 16a, 16b. The first panel 16a is positioned facing away from the space 20. Accordingly, upon full connection of the pair of first panels 12a, 12b and the pair of second panels 16a, 16b, the panel 12a and the panel 16a are positioned facing away from one another and the panel 12b and the panel 16b are positioned facing towards one another. The at least one air flow perforation 40 permits air 42 to flow from the second air pocket 18. The at least one air flow perforation 40 may be a hole of any suitable size, which allow the pressurized air 42 to flow through the first panel 16a of the pair of second panels 16a, 16b. The air 42 acts as a lubricant between the lateral transfer mattress 10 (when the panel 16a is facing downward) and an underlying surface (not shown in FIG. 4), such as a bed, etc., upon which the mattress 10 is being operated, which permits a patient 72 to be transferred with a minimum amount of effort, thereby reducing the risk of musculoskeletal injuries for both the patient 72 and the medical personnel moving and/or rotating the mattress 10 with the patient 72 positioned therein/thereon. As further shown in FIG. 4, the mattress 10 comprises a handle 44 connected to an edge 46 of a second panel 16b of the pair of second panels 16a, 16b. The handle 44 may be made of plastic, rubber, metal, or any other suitable material and may be secured to the second panel 16b. In an example, the handle 44 can be used to maneuver the mattress 10 or the pair of second panels 16a, 16b, or can be used as a mechanism to secure the mattress 10 to an underlying surface (e.g., bed, etc.). In an example, the handles 34, 44 may be the same mechanism. In another example, the handles 34, 44 may be separate mechanisms that are aligned with one another. As further shown in FIG. 4, the mattress 10 comprises a handle 48 connected to a surface 49 of the panel 16a, wherein the surface 49 is positioned facing away from the space 20. The handle 48 may be positioned to be substantially flat against the surface 49 of the panel 16a, and the handle 48 may comprise the same type of material as the panel 16a, in an example.

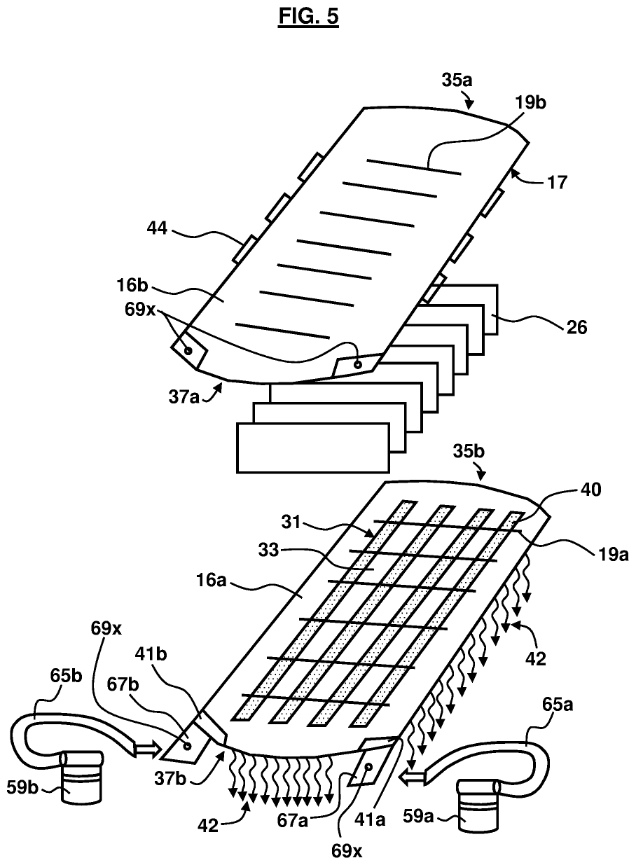

FIG. 5, with reference to FIGS. 1 through 4, illustrates a partial exploded view of the second pair of panels 16a, 16b of the mattress 10. A similar representation occurs for the first pair of panels 12a, 12b. However, for the purposes of illustration and a concise explanation, FIG. 5 depicts only the second pair of panels 16a, 16b. Reference to the terms “top” and “bottom” are described with reference to the orientation of the second pair of panels 16a, 16b, and are not meant to describe the only orientation for the second pair of panels 16a, 16b, and accordingly the embodiments herein are not restricted to this particular orientation and description of “top” and “bottom”. Again, a similar configuration occurs for the first pair of panels 12a, 12b. However, for the purposes of explanation, only the second pair of panels 16a, 16b are described with reference to FIG. 5. The top panel 16b is the panel that a patient 72 would lie on when the mattress 10 is in use as a lateral transfer mattress. The top panel 16b may comprise a nylon taffeta material or high-density polyethylene fiber material or similar material. The top panel 16b is connected to the bottom panel 16a by a perimeter seam of both the bottom and top panels 16a, 16b, which is either sewn or ultrasonically welded. There are handles 44 connected (e.g., sewn or ultrasonically welded, etc.) into the perimeter 17 and can be used to pull the mattress 10 (used as a lateral transfer mattress) laterally from one surface to another or to move a patient towards the head of a bed if the patient 72 has slipped towards the foot of a bed, for example. In between the top panel 16b and bottom panel 16a there are a plurality of baffles 26, which prevent the mattress 10 from taking on too much of a cylindrical shape when inflated by inflator 59a, 59b or any other suitable air source. The baffles 26 may comprise the same or similar materials as the bottom and top panels 16a, 16b and the baffles 26 are connected to the top panel 16b and bottom panel 16a with seams 19b, 19a that may be sewn or ultrasonically welded, for example.

The bottom panel 16a has substantially the same length and width dimensions as the top panel 16b and may be made of the same or similar material. The bottom panel 16a is perforated with a specific pattern of small holes (e.g., at least one air flow perforation 40). When the top panel 16b and bottom panel 16b are joined, it becomes inflatable. When inflated, pressurized air 42 flows through the at least one air flow perforation 40 and acts as a lubricant between the bottom panel 16a and an underlying surface (e.g., hospital bed, stretcher, etc.) so that a patient can be transferred with a minimum amount of effort, reducing the risk of musculoskeletal injuries. The at least one air flow perforation 40 on the bottom panel 16a may be arranged in a first pattern 31 of substantially elongated strips. There is also a second pattern 33 of non-perforated material in between the first pattern 31. The second pattern 33 of non-perforated material may be arranged in any suitable orientation (e.g., laterally, longitudinally, and a combination thereof).

The top panel 16b may comprise a first end 35a and an oppositely positioned second end 37a. Similarly, the bottom panel 16a may comprise a first end 35b and an oppositely positioned second end 37b such that first ends 35a, 35b align with one another, and second ends 37a, 37b align with one another. According to an example, the first ends 35a, 35b may correspond with the head end of a patient 72 while the second ends 37a, 37b may correspond with the feet end of a patient 72. However, the patient 72 may be positioned in an opposite orientation and accordingly the embodiments herein are not restricted to one particular orientation of the patient 72 in/on the mattress 10 (head end vs. feet end). A pair of pockets 41a, 41b are provided where the hoses 65a, 65b of the inflators 59a, 59b are inserted. The pair of pockets 41a, 41b are secured by flaps 67a, 67b that wrap around the inflator hoses 65a, 65b and are secured by closure mechanisms 69x such as snaps, Velcro® attachments, buttons, etc. The pair of pockets 41a, 41b and the flaps 67a, 67b may be configured in any suitable arrangement to engage and secure the hoses 65a, 65b for proper inflation of the mattress 10.

In the course of a 180° turning maneuver of the mattress 10 (e.g., rotation of the mattress 10 about a longitudinal axis of a patient 72), the at least one air flow perforation 40 on the bottom panel 16a loses contact with an underlying mattress surface (e.g., a bed, etc.). When the at least one air flow perforation 40 lose contact with the underlying mattress surface, the mattress 10 will rapidly deflate due to a loss of pressure inside either the first air pocket 14 or the second air pocket 18 (depending on which side of the mattress 10 is no longer in contact with the underlying mattress surface). In order to prevent this deflation, the embodiments herein use the longitudinal pleats 22 on the top panel 16b reduces the surface area of the top panel 16b and thus reduces the interior volume of the mattress 10. The pleats 22 are created by one or more longitudinal creases (further described below) in the top panel 16b and are flanked by two longitudinal mechanisms (further described below), such as zippers, etc., which allow the pleats 22 to be closed or open. Closing the pleats 22 reduces the interior volume of the mattress 10 so it can be used for the prone-to-supine maneuver and opening the pleats 22 restores the mattress 10 to its standard configuration for lateral transfer across horizontal surfaces. The pleats 22 can also be fixed in the closed position and reopened/reclosed as needed by a user. A variety of mechanisms or fasteners can be used to open and close the pleats 22.

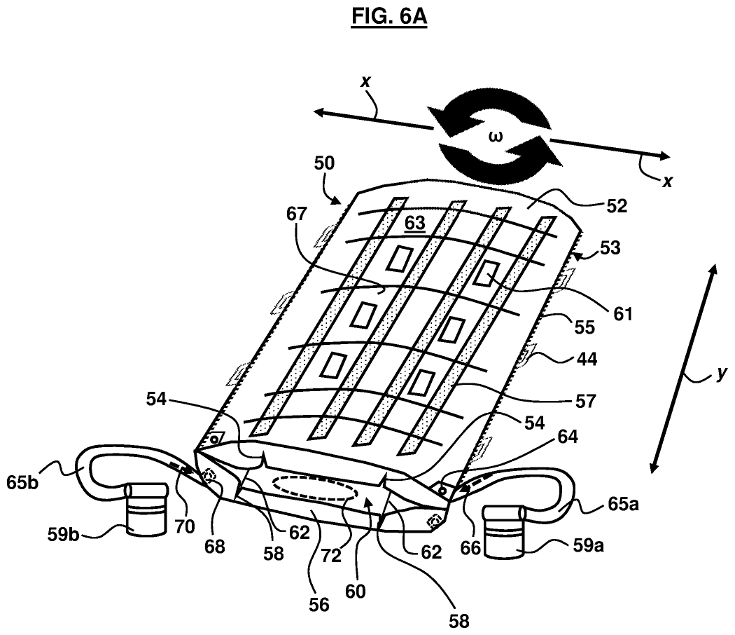

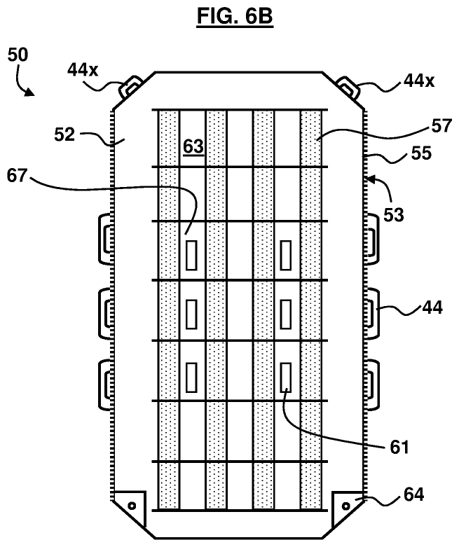

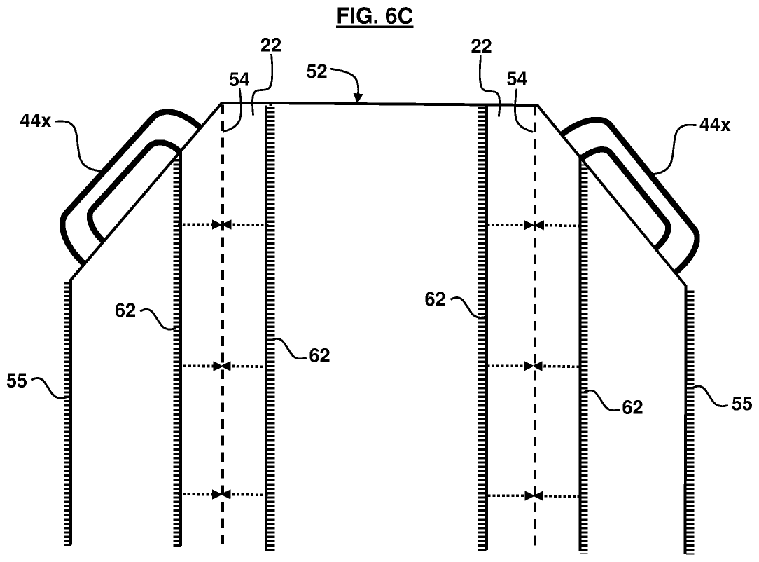

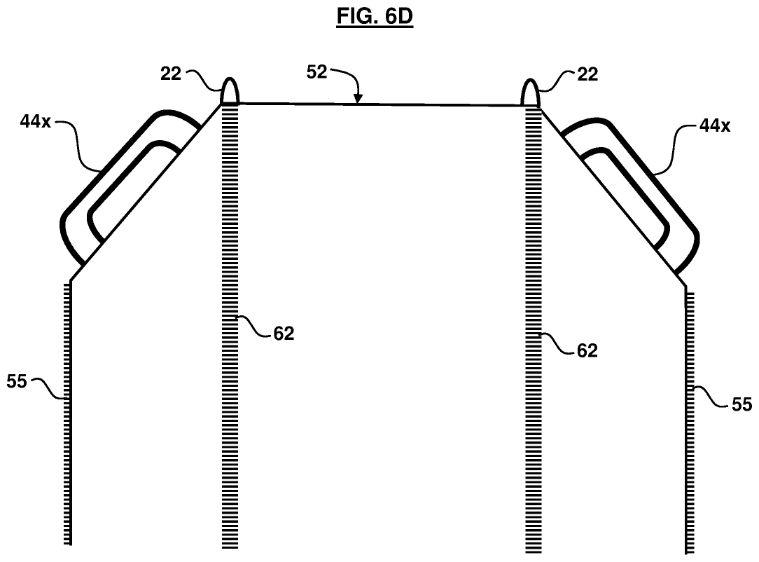

FIG. 6A illustrates another mattress 50 comprising a first inflatable cushion 52 comprising a first crease 54. The mattress 50 comprises a second inflatable cushion 56 comprising a second crease 58. The first inflatable cushion 52 and the second inflatable cushion 56 may comprise nylon taffeta material or high-density polyethylene fiber material or similar material, according to some examples. The first crease 54 and the second crease 58 may be configured as a bend or flexure in the material of the first inflatable cushion 52 and second inflatable cushion 56, respectively. The second inflatable cushion 56 is operatively connected to the first inflatable cushion 52. The mattress 50 comprises a space 60 between the first inflatable cushion 52 and the second inflatable cushion 56. The space 60 is configured to be appropriately sized to accommodate a patient 72. In use, the first inflatable cushion 52 and the second inflatable cushion 56 may be partially connected to each other such that the space 60 is not a bounded area defined by the area between the first inflatable cushion 52 and the second inflatable cushion 56. Then, a patient 72 may be inserted on the second inflatable cushion 56, and then the first inflatable cushion 52 and the second inflatable cushion 56 are fully connected thereby creating the space 60. The mattress 50 comprises a mechanism 62 to fold of any of the first crease 54 and the second crease 58. Example configurations of the mechanism 62 may comprise a zipper, hook and loop enclosure, plastic snaps, metal snaps, buttons, buckles, tracks, magnets, hook and eye, press studs, grommets, drawstrings, metal or plastic bars, or other mechanism that function to securely collapse and retain the first crease 54 and the second crease 58.

As further shown in FIG. 6A, the mattress 50 comprises a first mechanism 64 on the first inflatable cushion 52 to receive a first flow of air 66 to inflate the first inflatable cushion 52. The mattress 50 comprises a second mechanism 68 on the second inflatable cushion 56 to receive a second flow of air 70 to inflate the second inflatable cushion 56. In some examples, the first mechanism 64 and the second mechanism 68 may comprise nozzles or connectors configured to receive the hoses 65a, 65b of inflators 59a, 59b. In some examples, the inflators 59a, 59b may be any suitable type of air compressors, pumps, or other type of device capable of providing a source of air for inflating the first inflatable cushion 52 and the second inflatable cushion 56. The hoses 65a, 65b may be any suitable type of hose and may comprise any suitable type of material, length, and thickness to suitably transfer the air 66, 70 from the inflators 59a, 59b into the first inflatable cushion 52 and the second inflatable cushion 56.

Folding of any of the first crease 54 and the second crease 58 controls an internal volume of any of the first inflatable cushion 52 and the second inflatable cushion 56 by reducing the size of the first inflatable cushion 52 and the second inflatable cushion 56 due to a reduction in the amount of material associated with the first inflatable cushion 52 and the second inflatable cushion 56. As described above, the space 60 is configured to hold a person 72, and rotation w of the mattress 50 causes a corresponding rotation of the person 72 positioned in the space 72. Additionally, the mattress 50 is to allow lateral transfer x, y or a combination thereof, of the person 72 in addition to rotation w of the person 72. FIG. 6B, with reference to FIG. 6A, illustrates the first inflatable cushion 52 of the mattress 50. In FIG. 6B, the first inflatable cushion 52 is shown with extra handles 44x, which may assist in the transfer and/or rotation processes with respect to the mattress 50. A similar configuration may exist for the second inflatable cushion 56.

With reference to FIGS. 6A and 6B, perimeter seams 53 may be configured along the longitudinal edges of each of the first inflatable cushion 52 and the second inflatable cushion 56. Furthermore, mechanisms 55 such as zippers may be sewn or ultrasonically welded, etc. lengthwise from head to toe along the perimeter seams 53 of the mattress 50. Alternative mechanisms other than zippers may comprise a hook and loop enclosure, plastic snaps, metal snaps, buttons, buckles, tracks, magnets, hook and eye, press studs, grommets, drawstrings, metal or plastic bars, or other mechanism that function to securely collapse and retain the first crease 54 and the second crease 58.

The mechanisms 55 such as zippers, etc. allow the first inflatable cushion 52 and the second inflatable cushion 56 to be used on top one another, with a perforated panel 57 of each of the first inflatable cushion 52 and the second inflatable cushion 56 facing outward from the space 60. The first crease 54 and the second crease 58 face inward toward the space 60 where a patient 72 would be sandwiched therebetween. The first crease 54 and the second crease 58, when closed, create a substantially cylindrical shape for the mattress 50 that enables medical personnel or other user to gently roll the first inflatable cushion 52 and the second inflatable cushion 56 with the patient 72 therebetween 180° from the supine to the prone position and vice versa. Once the patient 72 is positioned in the space 60 between the first inflatable cushion 52 and the second inflatable cushion 56, the inflators 59a, 59b (or other air supply device(s)) are turned off, both the first inflatable cushion 52 and the second inflatable cushion 56 deflate and the mechanism 55 is opened (e.g., the zipper is unzipped) along the perimeter seams 53, the patient 72 may be retained on the second inflatable cushion 56. Upon completion of the movement or transfer of the patient 72 and any required medical treatment, the patient 72 may be removed from the second inflatable cushion 56 and the first inflatable cushion 52 and the second inflatable cushion 56 (which are now deflated) may be detached from each other and set aside and easily stored until needed again for patient transfer and/or rotation.

Flat lying handles 61 are positioned on the outer surface 63 of the first inflatable cushion 52 and the second inflatable cushion 56 of the mattress 50. In an example, the flat lying handles 61 may be positioned to substantially align with the handles 44. In an example, the flat lying handles 61 may comprise the same type of material as the first inflatable cushion 52 and the second inflatable cushion 56. As the mattress 50 is being turned or rotated (w) 180° (which may occur in both directions for a complete revolution of 360°), the ease and safety of the maneuver is greatly improved by the availability of several handles 44, 44x, 61 on both the first inflatable cushion 52 and the second inflatable cushion 56 of the mattress 50. The first inflatable cushion 52 and the second inflatable cushion 56 is perforated in a pattern in the perforated panel 57, which yields both lateral and longitudinal tracks of unperforated material. The flat lying handles 61 are affixed to these tracks of unperforated material in line with the handles 44 that are affixed to the perimeter seams 53 of the mattress 50, according to an example. The perforated panel 57 may be configured as a series of pinholes or other suitably-sized holes. The flat lying handles 61 on the outer surface 63 of the first inflatable cushion 52 and the second inflatable cushion 56 of the mattress 50 enable two people (e.g., medical personnel, etc.) to conduct a smooth, uninterrupted and safe 180° turn/rotation (w) in either direction, in accordance with the embodiments herein.

FIG. 6C, with reference to FIGS. 6A and 6B, illustrate an isolated portion of the first inflatable cushion 52 with the first crease 54 in an open configuration. A similar representation may occur for the second inflatable cushion 56. However, for the purposes of a concise and non-repetitive explanation, only the configuration of the first inflatable cushion 52 are described herein. A pair of first creases 54 are shown as an exemplary illustration of the first inflatable cushion 52. The mechanism 62 is shown on opposite sides of each of the pair of first creases 54. The dotted arrows depict the direction of the folding to align the mechanism 62 together for folding the first crease 54 and closing pleats 22 created by the first crease 54. FIG. 6D, with reference to FIGS. 6A through 6C, illustrate an isolated portion of the first inflatable cushion 52 with the first crease 54 (of FIG. 6C) in a closed configuration. The mechanism 62 is shown in the closed position, which closes the pleats 22 along the first crease 54. Moreover, the first crease 54 shown in FIG. 6D is shown outwardly extending from the first inflatable cushion 52 is a generally bulbous shaped protrusion. This protrusion is the result of the closing of the mechanism 62, which closes the pleats 22, thereby causing excess material of the pleats 22 to outwardly protrude (but is still connected) from the first inflatable cushion 52.

Once the pleats 22 are closed securely for the first inflatable cushion 52, the second inflatable cushion 56 with closed pleats 22 can be placed on top of the patient 72 with a bottom panel (such as bottom panel 16a) facing up and away from the patient 72. The first inflatable cushion 52 is joined with the second inflatable cushion 56 along the longitudinal perimeter seams 53 with mechanisms 55 such as zippers or similar fasteners as described above. Once the first inflatable cushion 52 and the second inflatable cushion 56 are fastened together, the hoses 65a, 65b of the inflators 59a, 59b can be inserted into the pair of pockets 41a, 41b, respectively, for each inflation of the first inflatable cushion 52 and the second inflatable cushion 56. After suitable inflation of the first inflatable cushion 52 and the second inflatable cushion 56, the hoses 65a, 65b may continue to be attached to the first inflatable cushion 52 and the second inflatable cushion 56 during the patient-handling maneuver. The inflators 59a, 59b are turned off and the hoses 65a, 65b may be disconnected and detached from the respective first inflatable cushion 52 and the second inflatable cushion 56 once the patient-handling maneuver has been completed, and the first inflatable cushion 52 and the second inflatable cushion 56 may deflate on their own.

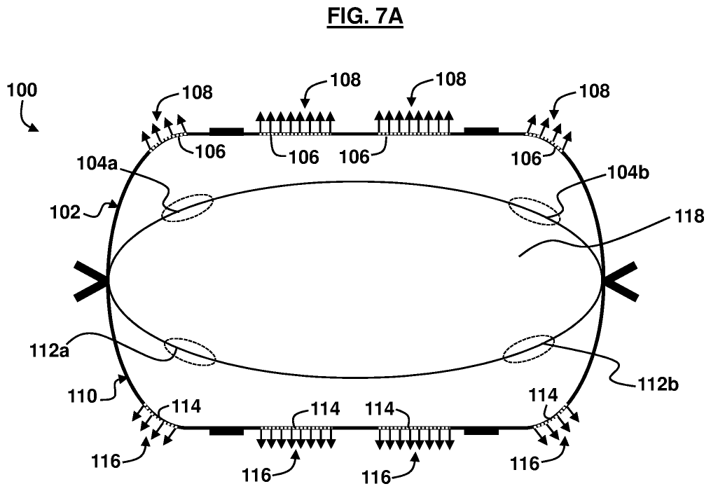

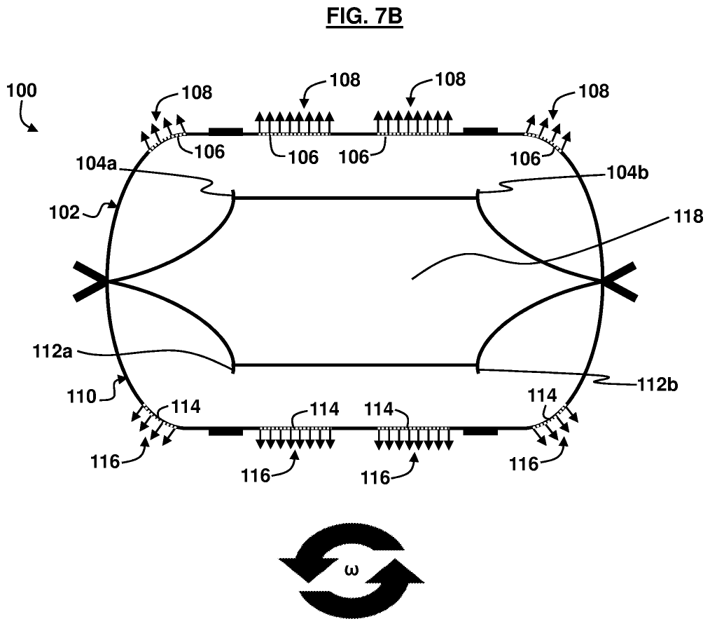

FIGS. 7A and 7B illustrate another mattress 100 comprising a first inflatable cushion 102 comprising a first set of pleats 104a, 104b that are configured to open and close. A first set of perforations 106 are provided in the first inflatable cushion 102 to exhaust a first flow of air 108 transmitted through the first inflatable cushion 102. The mattress 100 comprises a second inflatable cushion 110 detachably connected to the first inflatable cushion 102. The second inflatable cushion 110 comprises a second set of pleats 112a, 112b that are foldable. Additionally, a second set of perforations 114 are provided in the second inflatable cushion 110 to exhaust a second flow of air 116 transmitted through the second inflatable cushion 110. The first inflatable cushion 102 and the second inflatable cushion 110 may each comprise nylon taffeta material or high-density polyethylene fiber material or similar material, according to some examples. The first set of perforations 106 and the second set of perforations 114 may be configured as a series of pinholes or other suitably-sized holes that permit the first flow of air 108 and the second flow of air 116 to flow therefrom, according to the embodiments herein.

The closing of any of the first set of pleats 104a, 104b and the second set of pleats 112a, 112b is to define a space 118 between the first inflatable cushion 102 and the second inflatable cushion 110 and reduces an interior volume in any of the first inflatable cushion 102 and the second inflatable cushion 102 upon inflation of any of the first inflatable cushion 102 and the second inflatable cushion 110. For example, when folded in a closed position, the first set of pleats 104a, 104b and the second set of pleats 112a, 112b reduce the width of the first inflatable cushion 102 and the second inflatable cushion 110 by approximately 1 to 4 inches per pleat (although other amounts are possible in accordance with the embodiments herein), thus causing the mattress 100 to take on a crescent or half-hexagon shape when inflated. According to an example, the space 118 may be configured to accommodate a patient 72 (now shown in FIGS. 7A and 7B) for lateral and/or rotational transfer.

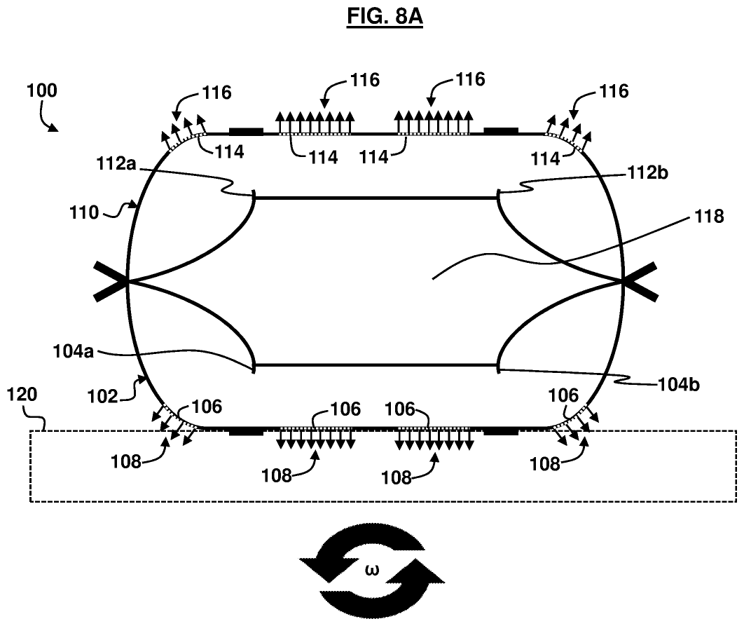

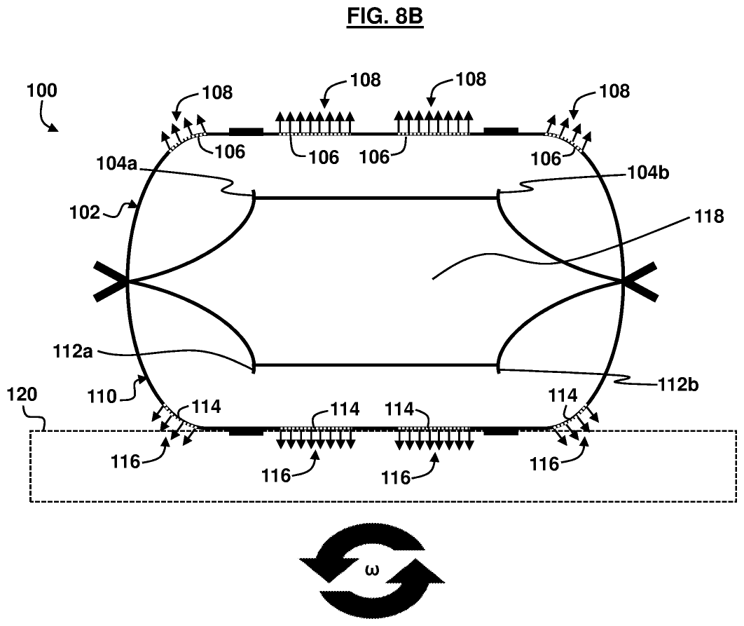

As shown in FIG. 8A, with reference to FIGS. 7A and 7B, the mattress 100 has been rotated 180°. The first flow of air 108 is shown being exhausted through the first set of perforations 106 to reduce friction between the first inflatable cushion 102 and an underlying surface 120 to permit rotational movement w of the first inflatable cushion 102 (and lateral movement of the mattress 100, if desired) at a reduced required transfer force.

As shown in FIG. 8B, with reference to FIGS. 7A through 8A, the mattress 100 has been rotated 180° again back to its original position. The second flow of air 116 is shown being exhausted through the second set of perforations 114 to reduce friction between the second inflatable cushion 110 and an underlying surface 120 to permit rotational movement w of the second inflatable cushion 110 (and lateral movement of the mattress 100, if desired) at a reduced required transfer force.

In addition to creating a substantially hexagonal shape for the mattress 100, the first set of pleats 104a, 104b and the second set of pleats 112a, 112b overcome an obstacle to using a standard, conventional lateral transfer mattress as a prone to supine positioner. Without the first set of pleats 104a, 104b and the second set of pleats 112a, 112b the first inflatable cushion 102 and the second inflatable cushion 110 would quickly deflate when the first set of perforations 106 and the second set of perforations 114 on the first inflatable cushion 102 and the second inflatable cushion 110, respectively, are lifted away from the underlying surface 120 on which the mattress 100 is positioned and exposed to the atmosphere. The back pressure provided by the contact with the underlying surface 120 keeps the mattress 100 inflated so a patient 72 (not shown in FIGS. 8A and 8B) is continually lifted throughout the transfer process. The first set of pleats 104a, 104b and the second set of pleats 112a, 112b replace the need for continuous contact with the horizontal surface 120 because the folded configuration of the first set of pleats 104a, 104b and the second set of pleats 112a, 112b reduce the total width of the first inflatable cushion 102 and the second inflatable cushion 110 of the transfer mattress 100 compared to the unfolded position of the first set of pleats 104a, 104b and the second set of pleats 112a, 112b. Varying the width of the first set of pleats 104a, 104b and the second set of pleats 112a, 112b may be suitably effective at maintaining the buoyancy of both the first inflatable cushion 102 and the second inflatable cushion 110 used to encapsulate the patient. The reduction in the width of the first inflatable cushion 102 and the second inflatable cushion 110 translates into a significantly and sufficiently enough reduction of the respective internal volumes of the first inflatable cushion 102 and the second inflatable cushion 110 that it substantially mimics the back pressure created by contact with the underlying surface 120. In an example, the same amount of air pressure is being pumped into the first inflatable cushion 102 and the second inflatable cushion 110 by an external air supply such as inflators 59a, 59b (not shown in FIGS. 8A and 8B), but the internal volumes of the first inflatable cushion 102 and the second inflatable cushion 110 have been sufficiently reduced due to the closing of the first set of pleats 104a, 104b and the second set of pleats 112a, 112b to create enough back pressure to keep both the first inflatable cushion 102 and the second inflatable cushion 110 inflated even when the first set of perforations 106 and the second set of perforations 114 are out of contact with the underlying surface 120 and exposed to the atmosphere.

The first set of pleats 104a, 104b and the second set of pleats 112a, 112b can be sewn or ultrasonically welded together in one example. In another example, the first set of pleats 104a, 104b and the second set of pleats 112a, 112b can be temporarily fastened or zipped closed, in order to perform the supine-to-prone maneuver and vice versa, but then unfastened or unzipped open so the mattress 100 can be once again used for lateral transfers and repositioning on horizontal surfaces; e.g., the underlying surface 120.

To execute the supine-to-prone maneuver, the first inflatable cushion 102 and the second inflatable cushion 110 are activated; e.g., inflated. The second inflatable cushion 110 is described as being the top cushion first as shown in FIG. 8A. However, this is just an example, and the first inflatable cushion 102 may be the top cushion first prior to rotation of the mattress 100. Air inflates both of the first inflatable cushion 102 and the second inflatable cushion 110 with a patient 72 (not shown in FIGS. 8A and 8B) encapsulated in between the first inflatable cushion 102 and the second inflatable cushion 110; e.g., in the space 118 created by the first inflatable cushion 102 and the second inflatable cushion 110. From the side of the bed, the entire mattress 100 is pulled towards one side the mattress 100 using the handles 44. The mattress 100 is then lifted up vertically by the handles 44. At the same time, a person on the opposite side of the mattress 100 can grasp one or more of the flat lying handles 126 on the first inflatable cushion 102 or the second inflatable cushion 110 and pull them in a rotational direction. As the mattress 100 moves through the 180° turn, both people (e.g., medical personnel or other users, etc.) can move their respective hands from one set of handles 44, 126 to another so the action is smooth and consistent through the arc of the turn/rotation.

Once the 180° turn is completed, as shown in FIG. 8B, and the patient 72 (not shown in FIGS. 8A and 8B) is lying in the prone position, the inflators 59a, 59b (not shown in FIGS. 8A and 8B) can be deactivated. The first inflatable cushion 102 and the second inflatable cushion 110 will now deflate. The new top cushion (e.g., first inflatable cushion 102) can be unfastened from the new bottom cushion (e.g., second inflatable cushion 110) and removed and stored for later use. Additionally, upon re-inflating the first inflatable cushion 102 and the second inflatable cushion 110, the closed first set of pleats 104a, 104b and second set of pleats 112a, 112b can be unfastened and opened so the mattress 100 can be used for lateral transfer across horizontal surfaces 120.

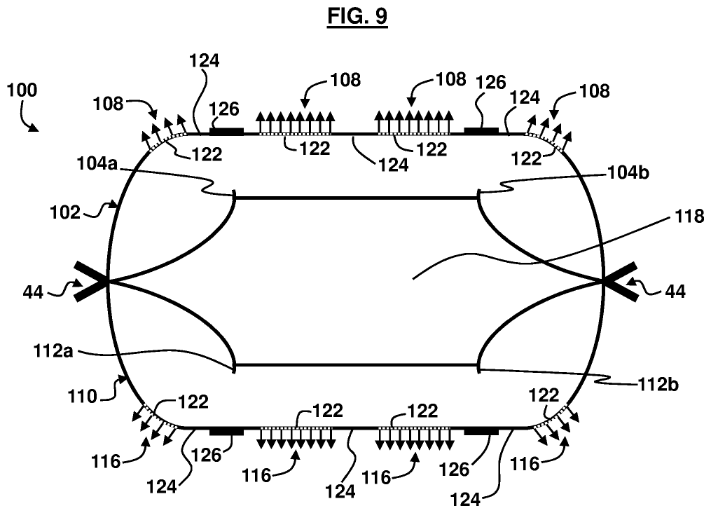

As shown in FIG. 9, with reference to FIGS. 7A through 8B, each of the first inflatable cushion 102 and the second inflatable cushion 110 comprises a perforation portion 122 and a non-perforation portion 124. The non-perforation portion 124 comprises at least one handle 126 that lies substantially flat against the non-perforation portion 124. The handle 126 may comprise the same type of material as the first inflatable cushion 102 and the second inflatable cushion 110, and more particularly the non-perforation portion 124, in an example. The perforation portion 122 comprises a series of pinholes or other suitably-sized holes to permit the flow of air 108, 116 therethrough from the first inflatable cushion 102 and the second inflatable cushion 110, respectively.

The embodiments herein provide a combination lateral transfer and rotational movement mattress 10, 50, 100 to permit easy of transfer and/or movement of a patient 72. The use of the mattress 10, 50, 100 permits a reduction in the transfer force required for such transfer and/or movement for medical personnel or other user. Moreover, the mattress 10, 50, 100 may be inflated and deflated quickly and stored easily to further enhance the industrial operability of the mattress 10, 50, 100. The use of collapsible pleats 22, 104a, 104b, 112a, 112b and foldable creases 54, 58 enable the mattress 10, 50, 100, respectively, to reduce an internal volume to permit proper transfer and/or movement of a patient 72 on/in the mattress 10, 50, 100.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Those skilled in the art will recognize that the embodiments herein can be practiced with modification within the spirit and scope of the appended claims.

What is claimed is:

1. A mattress comprising:
a pair of first panels connected to each other and defining a first air pocket therebetween; and
a pair of second panels connected to each other and defining a second air pocket therebetween,
wherein the pair of first panels and the pair of second panels are operatively connected to each other defining a space between the pair of first panels and the pair of second panels, and
wherein the pair of first panels and the second pair of panels each comprise collapsible pleats to control a volume of the space.

2. The mattress of claim 1, comprising:
a first set of baffles separating the pair first panels from each other; and
a second set of baffles separating the pair of second panels from each other.

3. The mattress of claim 1, comprising a mechanism to collapse and retain the pleats in a closed position.

4. The mattress of claim 3, wherein the closed position of the pleats causes the volume of any of the first air pocket and the second air pocket to reduce.

5. The mattress of claim 1, comprising at least one air flow perforation in a first panel of the pair of first panels, wherein the first panel is positioned away from the space, and wherein the at least one air flow perforation permits air to flow from the first air pocket.

6. The mattress of claim 5, comprising a handle connected to an edge of a second panel of the pair of first panels.

7. The mattress of claim 5, comprising a handle connected to a surface of the first panel, wherein the surface is positioned away from the space.

8. The mattress of claim 1, comprising at least one air flow perforation in a first panel of the pair of second panels, wherein the first panel is positioned away from the space, and wherein the at least one air flow perforation permits air to flow from the second air pocket.

9. The mattress of claim 8, comprising a handle connected to an edge of a second panel of the pair of second panels.

10. The mattress of claim 8, comprising a handle connected to a surface of the first panel, wherein the surface is positioned away from the space.

11. A mattress comprising:
a first inflatable cushion comprising a first crease;
a second inflatable cushion comprising a second crease, wherein the second inflatable cushion is operatively connected to the first inflatable cushion;
a space between the first inflatable cushion and the second inflatable cushion; and
a mechanism to fold of any of the first crease and the second crease.

12. The mattress of claim 11, comprising:
a first mechanism on the first inflatable cushion to receive a first flow of air to inflate the first inflatable cushion; and
a second mechanism on the second inflatable cushion to receive a second flow of air to inflate the second inflatable cushion.

13. The mattress of claim 11, wherein folding of any of the first crease and the second crease controls an internal volume of any of the first inflatable cushion and the second inflatable cushion.

14. The mattress of claim 11, wherein the space is configured to hold a person, and wherein rotation of the mattress causes rotation of the person.

15. The mattress of claim 14, wherein the mattress is to allow lateral transfer of the person.

16. A mattress comprising:
a first inflatable cushion comprising:
a first set of pleats that are configured to open and close; and
a first set of perforations to exhaust a first flow of air transmitted through the first inflatable cushion;
a second inflatable cushion detachably connected to the first inflatable cushion, wherein the second inflatable cushion comprises:
a second set of pleats that are foldable; and
a second set of perforations to exhaust a second flow of air transmitted through the second inflatable cushion,
wherein closing of any of the first set of pleats and the second set of pleats is to define a space between the first inflatable cushion and the second inflatable cushion and reduces an interior volume in any of the first inflatable cushion and the second inflatable cushion upon inflation of any of the first inflatable cushion and the second inflatable cushion.

17. The mattress of claim 16, wherein the first flow of air exhausted through the first set of perforations is to reduce friction between the first inflatable cushion and an underlying surface to permit rotational movement of the first inflatable cushion at a reduced required transfer force.

18. The mattress of claim 16, wherein the second flow of air exhausted through the second set of perforations is to reduce friction between the second inflatable cushion and an underlying surface to permit rotational movement of the second inflatable cushion at a reduced required transfer force.

19. The mattress of claim 16, wherein each of the first inflatable cushion and the second inflatable cushion comprises a perforation portion and a non-perforation portion.

20. The mattress of claim 19, wherein the non-perforation portion comprises at least one handle that lies substantially flat against the non-perforation portion.
